(19) United States
(12) Patent Application Publication
(10) Pub. No.: US 2019/0268742 A1
(43) Pub. Date: Aug. 29, 2019

(54) MOVING BODY ASSISTANCE DEVICE, MOVING BODY ASSISTANCE SYSTEM, AND MOVING BODY ASSISTANCE METHOD

(71) Applicant: Panasonic Intellectual Property Management Co., Ltd., Osaka (JP)

(72) Inventors: Yoshiyuki TAKAHIRA, Kyoto (JP); Shohei KIKUTA, Hyogo (JP); Shojiro KIDO, Osaka (JP); Toshiya MORIWAKI, Osaka (JP)

(21) Appl. No.: 16/263,516

(22) Filed: Jan. 31, 2019

(30) Foreign Application Priority Data
Feb. 27, 2018 (JP) 2018-033021

(51) Int. Cl. H04W 4/46; G05D 1/00; G05D 1/02

(52) U.S. Cl. CPC H04W 4/46; G05D 1/0022; G05D 1/0234; G05D 1/0033; G05D 1/0061

(57) ABSTRACT

A moving body assistance device includes: an obtainment unit that obtains identification information for identifying at least one automobile or at least one person in the at least one automobile, by receiving an optical signal transmitted by the at least one automobile; a communication unit that receives feature information from a server disposed outside of an automobile and the at least one automobile, the feature information corresponding to the identification information and indicating a feature about the at least one automobile or the at least one person in the at least one automobile; and a control unit that determines whether a predetermined condition is satisfied according to the feature information, selects, as a selected automobile, one of the at least one automobile according to a determination result, and causes the communication unit to establish communication with the selected automobile.

### CROSS REFERENCE TO RELATED APPLICATION

This application claims the benefit of priority of Japanese Patent Application Number 2018-033021 filed on Feb. 27, 2018, the entire content of which is hereby incorporated by reference.

### BACKGROUND

### 1. Technical Field

The present disclosure relates to moving body assistance devices, moving body assistance systems, and moving body assistance methods.

### 2. Description of the Related Art

Conventional techniques have been proposed in which an autonomous car is caused to track a car in front manually driven by a user. Specifically, a car travel control device is disclosed that includes an other car state receiving unit that receives, from other traveling cars, information indicating a control operation amount, a travel state amount, and car specifications, and a control operation amount calculating unit that calculates a control operation amount of a car so that the car is caused to track a car right in front, according to at least information about the car right in front included in the information received by the other car state receiving unit, and a state of the car detected (see, for example, Patent Literature (PTL) 1 (Japanese Unexamined Patent Application Publication No. 05-170008)).

### SUMMARY

For example, in a place where automobiles frequently come and go, it is difficult to identify an automobile to be a communication target for tracking. Even if an automobile to be tracked is identified and communication is established between the automobile to be tracked and an automobile of a user, there is no guarantee that the user can head for a desired destination. Because of these situations, there is a demand for extracting an automobile heading for a destination desired by a user even in a place where automobiles frequently come and go.

In view of this, the present disclosure has an object to provide a moving body assistance device, a moving body assistance system, and a moving body assistance method that can extract a desired automobile from automobiles.

In order to achieve the above object, a moving body assistance device according to one aspect of the present disclosure is a moving body assistance device that is installed in a first moving body and assists movement of the first moving body by communicating with at least one second moving body traveling in surroundings of the first moving body. The moving body assistance device includes: an obtainment unit that obtains identification information for identifying the at least one second moving body or at least one person in the at least one second moving body, by receiving an optical signal transmitted by the at least one second moving body; a communication unit that receives feature information from a server disposed outside of the first moving body and the at least one second moving body, the feature information corresponding to the identification information and indicating a feature about the at least one second moving body or the at least one person in the at least one second moving body; and a control unit that determines whether a predetermined condition is satisfied according to the feature information, selects, as a selected moving body, one of the at least one second moving body according to a determination result, and causes the communication unit to establish communication with the selected moving body.

Moreover, a moving body assistance system according to one aspect of the present disclosure includes a first moving body and at least one second moving body each having installed therein a corresponding moving body assistance device.

Furthermore, a moving body assistance method according to one aspect of the present disclosure is a moving body assistance method for assisting movement of a first moving body by communicating with at least one second moving body traveling in surroundings of the first moving body. The moving body assistance method includes: obtaining identification information for identifying the at least one second moving body or at least one person in the at least one second moving body, by receiving an optical signal transmitted by the at least one second moving body; receiving, from a server, feature information corresponding to the identification information and indicating a feature about the at least one second moving body; and determining whether a predetermined condition is satisfied according to the feature information, selecting, as a selected moving body, one of the at least one second moving body according to a determination result, and establishing communication with the selected moving body.

According to the present disclosure, it is possible to extract a desired automobile from automobiles.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a block diagram illustrating a moving body assistance system according to Embodiment 1.

FIG. 2 is a schematic diagram illustrating the moving body assistance system according to Embodiment 1.

FIG. 3 is an explanatory schematic diagram illustrating the operation of the moving body assistance system according to Embodiment 1.

FIG. 4 is a sequence diagram illustrating the operation of the moving body assistance system according to Embodiment 1.

FIG. 5 is a flowchart illustrating the operation of a moving body assistance device according to Embodiment 1.

FIG. 6 is a sequence diagram illustrating the operation of a moving body assistance system according to Embodiment 2.

### DETAILED DESCRIPTION OF THE EMBODIMENTS

Hereinafter, embodiments of the present disclosure will be described with reference to the drawings. Each of the embodiments described below represents a generic or specific example. The numerical values, shapes, materials, structural components, the arrangement and connection of the structural components, steps, the order of the steps, etc. shown in the following embodiments are mere examples, and are not intended to limit the scope of the present disclosure. Furthermore, among the structural components in the following embodiments, structural components not recited in any one of the independent claims which indicate the broadest concepts of the present disclosure are described as optional structural components.

It should be noted that the figures are schematic diagrams and are not necessarily precise illustrations. Furthermore, in the figures, substantially identical components are assigned the same reference signs, and overlapping description thereof is omitted or simplified.

The following describes a moving body assistance device, a moving body assistance system, and a moving body assistance method according to each of embodiments of the present disclosure.

### Embodiment 1

[Configuration]

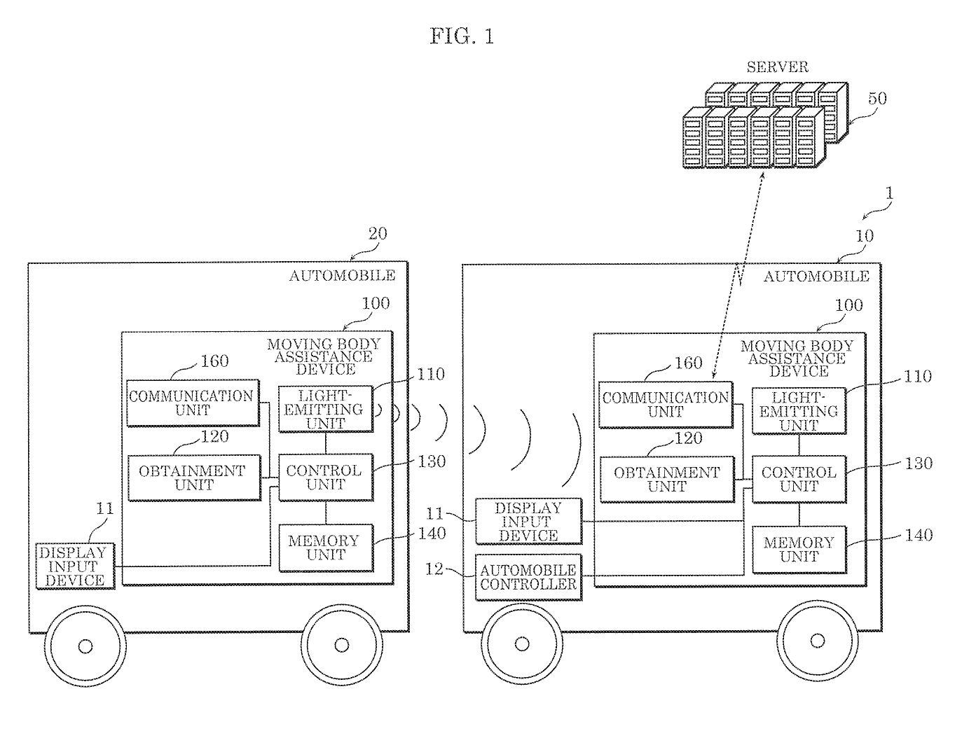

FIG. 1 is a block diagram illustrating moving body assistance system 1 according to Embodiment 1.

As shown in FIG. 1, moving body assistance system 1 can extract one of one or more automobiles 20 that can pull automobile 10, from one or more automobiles 20 traveling in the surroundings of automobile 10 and different from automobile 10, and have, when obtaining an acceptance from extracted automobile 20, automobile 20 pull. Here, the term “pull” does not mean that automobile 10 and automobile 20 are physically connected with a tow tool etc., and automobile 10 is physically pulled by automobile 20, but means that when communication between automobile 10 and automobile 20 is established, automobile 10 performs automated driving and both the automobiles move in a manner that automobile 10 tracks automobile 20. In this case, automobile 20 may be automatically driven or manually driven. Here, the term “automated driving” means automatic traveling with no human control, and does not include traveling in a state in which the accelerator is released during traveling. Traveling in such a state means driving manually.

Moving body assistance system 1 includes automobile 10 including moving body assistance device 100, and one or more automobiles 20 including moving body assistance device 100.

Automobile 10 reaches a predetermined destination by automated driving. In other words, automobile 10 can travel on a road while switching between a manual mode in which a user manually drives automobile 10 and an automatic mode in which automated driving is performed.

Automobile 10 is driven by the user and includes moving body assistance device 100, display input device 11, and, for example, an integration unit, an accelerator actuator, a brake actuator, a steering actuator, etc. (not shown). Moreover, another automobile 20 is driven by a person, another user, and includes moving body assistance device 100. Automobile 10 is one example of a first moving body. Another automobile 20 is one example of a second moving body. The automobiles are used as one example of the first moving body and the second moving body in the present embodiment, but the first moving body and the second are not limited to these. For example, the first moving body and the second moving body may each be an aircraft, a watercraft, etc.

Moving body assistance device 100 is installed in automobile 10 and assists movement of automobile 10 by communicating with one or more automobiles 20 traveling in the surroundings of automobile 10. In the present embodiment, moving body assistance device 100 includes light-emitting unit 110, obtainment unit 120, control unit 130, memory unit 140, and communication unit 160.

Light-emitting unit 110 transmits an optical signal to one or more automobiles 20. Specifically, light-emitting unit 110 is a device dedicated for optical communication that is different from the stop lamps and tail lamps of automobile 10 and one or more automobiles 20. Light-emitting unit 110 emits modulated light modulated according to first feature information transmitted by moving body assistance device 100.

Light-emitting unit 110 is attached to, for example, the rear or side of an automobile. The reason for this is to output an optical signal toward a following automobile hoping for pull. Here, the term “automobile” includes automobile 10 and one or more automobiles 20. Modulated light is, for example, visible light, and may be invisible light, such as infrared light, if obtainment unit 120 can obtain invisible light.

Light-emitting unit 110 includes, for example, a board and light-emitting diode (LED) elements mounted on the board (not shown).

The board is a printed circuit board for mounting LED elements and is approximately rectangular in shape. Examples of the board include a resin board based on resin, a metal base board based on metal, and a ceramic board made of ceramic. The LED elements are mounted on the board. For example, the LED elements are arranged on the board. The LED elements may be one example of light-emitting unit 110.

The LED elements emit, for example, white light. In the present embodiment, the LED elements may be RGB-type LED elements that emit blue light, green light, and red light. It should be noted that the LED elements may be surface mount device (SMD) LED elements and chip on board (COB) or bullet-shaped LED elements, and an optical element, such as a mirror and a lens, may be attached to the LED elements. The LED elements are not limited to the RGB three colors, and may be RGBW four colors or may be BW (blue and white) two colors.

Disposed on the board are signal lines that transmit control signals from control unit 130 and power lines that supply power from a power supply not shown. For example, the signal line and the power lines connect the LED elements in series. The LED elements receive the supply of power from the power supply via the power lines, and emit predetermined light according to a control signal received via the signal lines.

Obtainment unit 120 is, for example, an imaging device, such as a dashboard camera. It should be noted that obtainment unit 120 may be, for example, an image sensor that can receive an optical signal. Examples of the image sensor include a complementary metal-oxide-semiconductor (CMOS) image sensor and a charge coupled device (CCD) image sensor. Moreover, obtainment unit 120 may be a smartphone, a tablet terminal, etc., which incorporates such an imaging device. In this case, it is desirable that obtainment unit 120 be secured with a removable securing component disposed in the interior of the automobile.

In the present embodiment, obtainment unit 120 is, for example, a dashboard camera. It should be noted that since obtainment unit 120 only has to obtain from each of one or more automobiles 20 second feature information indicating features of each of one or more persons in automobile 20, obtainment unit 120 is not limited to the dashboard camera, and that obtainment unit 120 may obtain the second feature information by a publicly-known means. In the present embodiment, obtainment unit 120 can receive an optical signal of automobile 20 within a distance of approximately 100 m from automobile 10. The second feature information indicating the features of the person in automobile 20 is also referred to as second feature information about automobile 20.

Obtainment unit 120 obtains the second feature information for identifying each of one or more automobiles 20, or each of the one or more persons in automobile 20, by receiving an optical signal transmitted by automobile 20. Obtainment unit 120 outputs the obtained second feature information to control unit 130. The second feature information is information for identifying automobile 20 or each person in automobile 20. The second feature information includes, for example, the destination of automobile 20, identification information for identifying automobile 20, information indicating a charge incurred from when a link for pulling is stared to when the destination is reached, and information indicating the interests of the person in automobile 20.

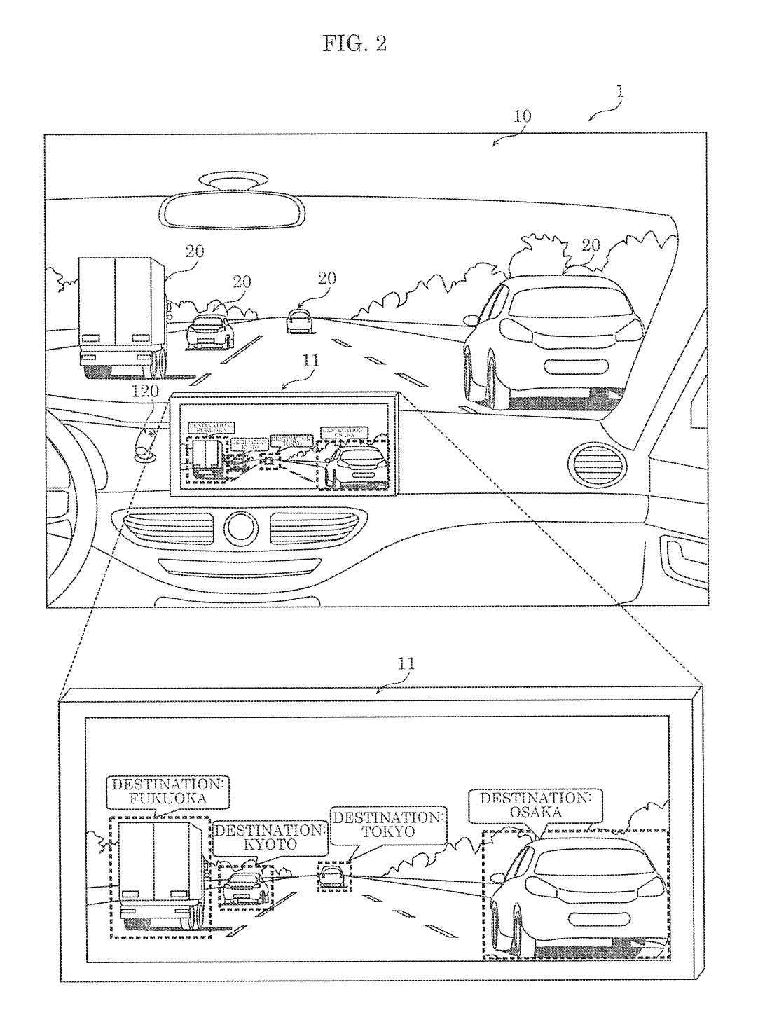

FIG. 2 is a schematic diagram illustrating moving body assistance system 1 according to Embodiment 1. In FIG. 2, a state is shown in which an image is partitioned into a segment for each of one or more automobiles 20. The segments are surrounded with dashed frames in order to identify one or more automobiles 20.

As shown in FIG. 2, obtainment unit 120 captures an image of one or more automobiles 20 in the surroundings of automobile 10. Obtainment unit 120 partitions the captured image into segments to recognize one or more automobiles 20. Examples of the segmentation method include Mean shift and k-means clustering used in image processing.

Obtainment unit 120 partitions the image into the segment for each of one or more automobiles 20 to appropriately recognize an optical signal sent by automobile 20. In other words, even when automobile 20 sends an optical signal, obtainment unit 120 does not easily falsely recognize an optical signal sent by one of one or more automobiles 20 as an optical signal sent by another automobile 20. This allows obtainment unit 120 to correctly recognize identification information associated with each of one or more automobiles 20.

As shown in FIG. 1, upon receiving identification information for identifying the person in automobile 20 indicated by an optical signal, control unit 130 transmits the identification information to server 50 via communication unit 160. Server 50 searches for second feature information corresponding to identification information, and transmits the second feature information to automobile 10. The identification information for identifying the person in automobile 20 is referred to as identification information about automobile 20.

Control unit 130 determines whether a predetermined condition is satisfied according to the second feature information, selects, as selected automobile 20a, one of one or more automobiles 20, and controls communication unit 160 so that communication with selected automobile 20a is established. In the present embodiment, control unit 130 determines whether a predetermined condition is satisfied by determining whether at least part of the second feature information obtained from server 50 that manages automobile 10 and selected automobile 20a is identical to first feature information stored in memory unit 140. A case in which at least part of the second feature information is identical to the first feature information is, for example, a case in which destinations included in the first feature information and the second feature information are the same.

Upon obtaining the second feature information from server 50, control unit 130 outputs the second feature information for display when control unit 130 determines that at least part of the obtained second feature information is identical to the first feature information stored in memory unit 140. For example, when control unit 130 outputs the second feature information to display input device 11, the user checks the second feature information displayed by display input device 11 and inputs a predetermined operation. Examples of the predetermined operation include an inquiry about whether pulling is possible when a condition offered by the person in automobile 20 matches a condition of the user of automobile 10, cancellation when a condition offered by the person in automobile 20 does not match a condition of the user of automobile 10, and browse of conditions offered by other automobiles. The inquiry about whether pulling is possible is an inquiry about whether a link to movement of automobile 20 is possible that is made to selected automobile 20a.

As shown in FIG. 2, in the present embodiment, the notes for one or more automobiles 20 and the destinations of one or more automobiles 20 are displayed on the outer surface of display input device 11.

As shown in FIG. 1, control unit 130 controls communication unit 160 so that communication is established with selected automobile 20a, one of one or more automobiles 20, according to a determination result. Specifically, when a condition offered by automobile 20 matches a condition of the user of automobile 10, the user transmits, to automobile 20 via display input device 11 and moving body assistance device 100, an inquiry about whether pulling is possible so that automobile 20 pulls automobile 10. In this case, control unit 130 transmits, to automobile 20 via communication unit 160, the inquiry about whether pulling is possible that is an operation inputted with display input device 11 by the user. In other words, when control unit 130 determines that at least part of the obtained second feature information is identical to the first feature information stored in memory unit 140, control unit 130 makes, to selected automobile 20a via communication unit 160, an inquiry about whether linking of movement of automobile 10 is possible. When control unit 130 determines that at least part of the obtained second feature information is identical to the first feature information stored in memory unit 140, control unit 130 causes the communication between selected automobile 20a and automobile 10 to be established. More specifically, when control unit 130 determines that at least part of the second feature information is identical to the first feature information stored in memory unit 140, and control unit 130 obtains from selected automobile 20a an acceptance for the inquiry about whether the linking of the movement of automobile 10 is possible, control unit 130 causes the communication between selected automobile 20a and automobile 10 to be established. To put it differently, by automobile 20 and automobile 10 communicating with each other, automobile 10 sequentially receives, for example, travel path information about a path on which another automobile 20 travels. In this case, automobile 10 may receive, from automobile 20 via communication unit 160, a control command for controlling the operation of automobile 10. Automobile 20 for which the communication is established with automobile 10 is selected automobile 20a, and is one example of a selected moving body that is one of one or more automobiles 20. Hereinafter, when the communication has been established, automobile 20 that is selected is referred to as selected automobile 20a.

When the communication is established between selected automobile 20a and automobile 10, control unit 130 switches from a manual mode in which the user drives automobile 10 to an automatic mode in which automated driving is performed so that the movement of automobile 10 is linked to the movement of selected automobile 20a. In other words, control unit 130 transmits an automatic mode switch command to the integration unit included in automobile 10. The integration unit switches from the manual mode to the automatic mode to set automobile 10 to automatic control.

After the linking of the movement of automobile 10 to the movement of selected automobile 20a is started, control unit 130 transmits completion information indicating the completion of the linking to server 50 via communication unit 160. In other words, when the linking is completed for automobile 10, control unit 130 transmits the completion information indicating the completion of the linking to server 50 via communication unit 160.

Memory unit 140 stores the first feature information indicating features of the user in automobile 10. Here, the first feature information includes, for example, the destination of the user in automobile 10, identification information for identifying automobile 10, and personal information about the user in automobile 10.

Communication unit 160 receives, from server 50 outside of automobile 10 and one or more automobiles 20, the second feature information about each of one or more automobiles 20 corresponding to identification information. In other words, communication unit 160 is a communication module that receives from server 50 the second feature information corresponding to the identification information, selects one of one or more automobiles 20 according to the second feature information, and wirelessly communicates with selected automobile 20a that is automobile 20 selected. When the communication is established between automobile 10 and selected automobile 20a, communication unit 160 receives, for example, travel path information from selected automobile 20a and outputs the travel path information to control unit 130. Besides, when the pulling is completed, communication unit 160 transmits the completion information to server 50. Communication unit 160 includes, for example, an antenna that wirelessly communicates with one or more automobiles 20 and server 50, and a semiconductor integrated circuit that processes wireless signals.

Display input device 11 is, for example, a car navigation device, and may be a smartphone, a tablet terminal, etc. that can wirelessly communicate with moving body assistance device 100. Display input device 11 displays, for example, the destination of each of one or more automobiles 20, information indicating a charge incurred from when a link for pulling is stared to when the link is ended, identification information for identifying automobile 20, and information indicating the interests of each of one or more persons in automobile 20, which are included in the second feature information. Display input device 11 is one example of a display.

It should be noted that in the present embodiment, display input device 11 is a single device that displays an image and receives input operations from the user, but, for example, a display unit, such as an organic EL display and a liquid crystal display, and an input unit, such as a capacitive touch panel and an inductive touch panel, may be separate devices. Furthermore, display input device 11 may be included in moving body assistance device 100.

The integration unit is an engine control unit or electronic control unit (ECU) that controls the entire operations of an automobile according to control commands received from moving body assistance device 100. In order to perform the controls according to the control commands, the integration unit outputs the control commands to the accelerator actuator, the brake actuator, the steering actuator, etc. The integration unit includes, for example, a CPU (central processing unit) as a main body, a ROM (read-only memory), a RAM (random-access memory), an input signal circuit, an output signal circuit, and a power supply circuit.

The accelerator actuator accelerates or decelerates the automobile according to a control command. In other words, the accelerator actuator controls, for example, a throttle position, an engine speed, intake air mass, an amount of fuel consumption, and ignition timing according to a control command from moving body assistance device 100, thereby managing an engine's operation according to the traveling state.

The steering actuator includes an electric motor and changes an orientation of steered wheels by the electric motor applying force to a rack and pinion mechanism. The steering actuator changes the orientation of the steered wheels by driving the electric motor according to a control command.

The brake actuator manages a brake system according to a control command, thereby controlling braking force applied to the wheels of the automobile. Examples of the brake system include a hydraulic brake system.

[Operation]

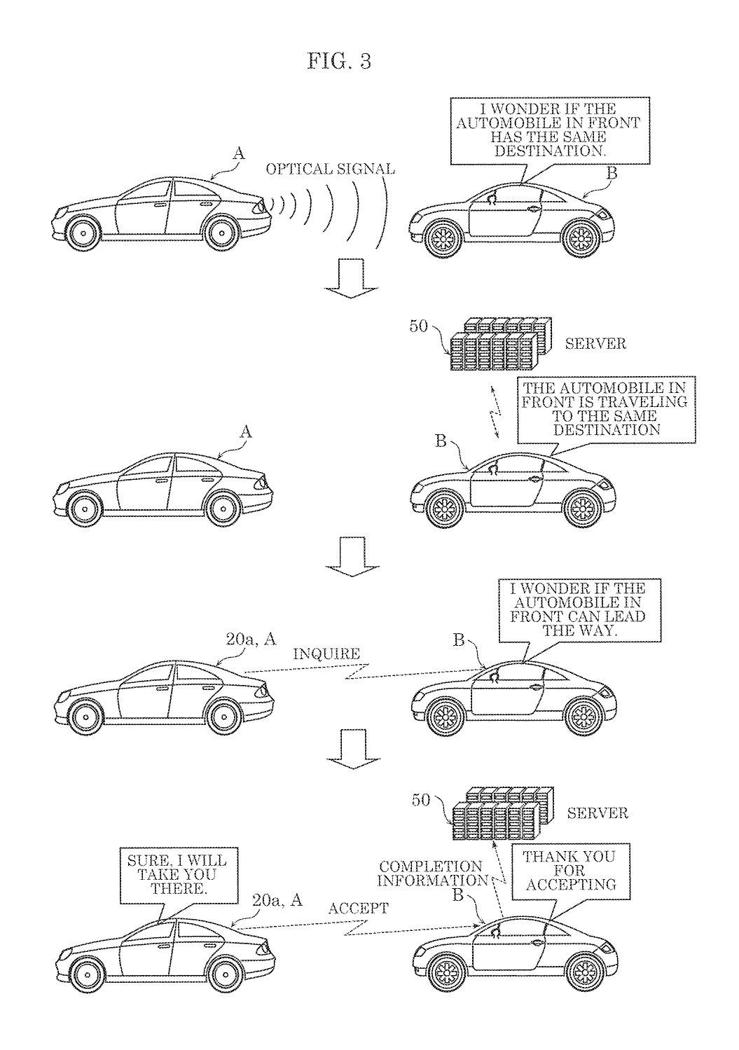

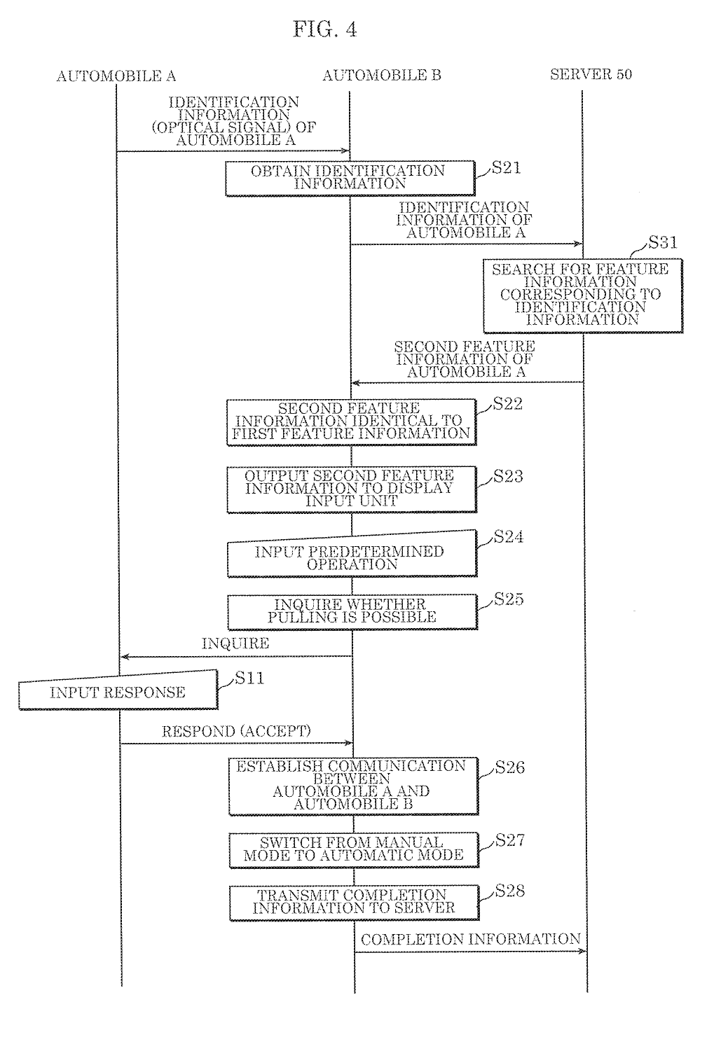

Next, the following describes the operation of moving body assistance device 100, moving body assistance system 1, and the moving body assistant method with reference to FIG. 3 and FIG. 4.

FIG. 3 is an explanatory schematic diagram illustrating the operation of moving body assistance system 1 according to Embodiment 1. FIG. 4 is a sequence diagram illustrating the operation of moving body assistance system 1 according to Embodiment 1.

In FIG. 3 and FIG. 4, a case is assumed in which automobile B receives an optical signal from one of automobiles A traveling on a road. Further, when an inquiry about whether pulling is possible is made to a person in automobile A, the person is assumed to affirmatively answer the inquiry. Moreover, it is assumed that automobile A continuously outputs the optical signal, and that the first feature information about a user of automobile B is inputted to automobile B in advance. Automobiles 10 and 20 shown in FIG. 3 are also referred to as automobiles A and B, respectively.

First, control unit 130 of automobile B obtains the optical signal outputted by automobile A via obtainment unit 120 (S21). Control unit 130 transmits to server 50 identification information about automobile A indicated by the optical signal.

Next, server 50 receives the identification information about automobile A from automobile B, and searches for feature information corresponding to the identification information (S31). Since the feature information about automobile A is the second feature information, server 50 transmits the second feature information to automobile B.

Next, control unit 130 receives, from server 50 via communication unit 160, a condition corresponding to the second feature information about automobile A. In other words, control unit 130 receives from server 50 information indicating the destination of automobile A, identification information for identifying automobile A, information indicating a charge incurred from when a link for pulling is started to when the destination is reached, information indicating the interests of a person in automobile A, etc. registered in server 50. Control unit 130 determines whether a predetermined condition is satisfied. Specifically, control unit 130 determines whether at least part of the second feature information is identical to the first feature information stored in memory unit 140 of automobile B. Here, control unit 130 determines a case in which the destinations are the same according to the above feature information as the at least part of the second feature information being identical to the first feature information (S22). It should be noted that the present embodiment is not limited to the case in which the destinations are the same, and a case in which the interests are the same in addition to the destinations, a case in which a charge preset by the user meets a user's expectations, etc. may be considered.

Next, because the at least part of the second feature information is identical to the first feature information, control unit 130 outputs the second feature information to display input device 11 (S23). With this, the user browses the second feature information indicating the destination of automobile A, the charge, etc. displayed by display input device 11. The user checks the second feature information displayed by display input device 11, and inputs a predetermined operation (S24).

Next, control unit 130 makes an inquiry to automobile A via communication unit 160 about whether pulling is possible (S25).

Next, the person in automobile A inputs a response to the inquiry about whether pulling is possible from automobile B (S11). In other words, upon receiving the inquiry about whether pulling is possible, automobile A outputs the inquiry to display input device 11. Here, the person in automobile A accepts the inquiry about whether pulling is possible via display input device 11. For this reason, automobile A transmits the acceptance for the inquiry about whether pulling is possible to automobile B.

Next, upon receiving the acceptance for the inquiry about whether pulling is possible from automobile A, control unit 130 of automobile B establishes communication between automobile A and automobile B (S26).

Automobile A that is one of one or more automobiles A becomes selected automobile 20a that is selected. As a result, automobile A and selected automobile 20a share, for example, travel path information about a path on which automobile A plans to travel.

Next, control unit 130 switches from the manual mode in which the user drives automobile B to the automatic mode in which the automated driving is performed so that movement of automobile B is linked to movement of selected automobile 20a (S27). In other words, control unit 130 transmits an automatic mode switch command to the integration unit included in automobile B. The integration unit switches from the manual mode to the automatic mode to set automobile B to automatic control.

Next, when the movement of automobile B is linked to the movement of selected automobile 20a, control unit 130 transmits completion information indicating the completion of the linking to server 50 via communication unit 160, server 50 managing automobile B and selected automobile 20a (S28). In this way, automobile B is pulled by selected automobile 20a to the destination of the user in a manner that automobile B tracks selected automobile 20a. After that, this process returns to the start.

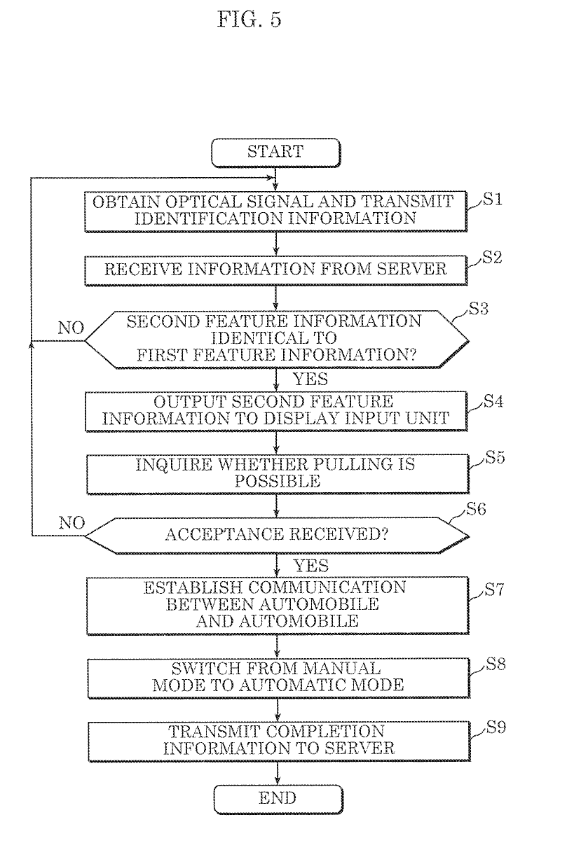

FIG. 5 is a flowchart illustrating the operation of moving body assistance device 100 according to Embodiment 1.

As shown in FIG. 5, first, control unit 130 of automobile B obtains, via obtainment unit 120, an optical signal outputted by automobile A (S1). Control unit 130 subsequently transmits to server 50 identification information about automobile A indicated by the optical signal (Si).

Next, control unit 130 receives from server 50 information indicating the destination of automobile A, identification information for identifying automobile A, information indicating a charge incurred from when a link for pulling is started to when the destination is reached, information indicating the interests of a person in automobile 20, etc. registered in server 50 (S2).

Next, control unit 130 determines whether a predetermined condition is satisfied. Specifically, control unit 130 determines whether at least part of second feature information is identical to first feature information stored in memory unit 140 (S3). Here, control unit 130 determines a case in which the destinations are the same according to the above feature information as the at least part of the second feature information being identical to the first feature information. It should be noted that the present embodiment is not limited to the case in which the destinations are the same, and a case in which the interests are the same in addition to the destinations, a case in which a charge preset by the user meets a user's expectations, etc. may be considered.

Next, when the at least part of the second feature information is identical to the first feature information (YES in S3), control unit 130 outputs the second feature information to display input device 11 (S4). With this, the user browses the second feature information indicating the destination of automobile A, the charge, etc. displayed by display input device 11. The user checks the second feature information displayed by display input device 11, and inputs a predetermined operation.

On the other hand, when the at least part of the second feature information is not identical to the first feature information (NO in S3), control unit 130 returns the process to step S1. It should be noted that when there are automobiles other than automobile A, identification signals obtained from the other automobiles in step Si may be transmitted to server 50. In this case, control unit 130 receives second feature information corresponding one-to-one with each of the other automobiles. For this reason, control unit 130 may return the process to step S2 to determine whether at least part of the second feature information about one of the automobiles other than another automobile A is identical to the first feature information. This indicates that when the at least part of the second feature information is not identical to the first feature information (NO in S3), it is not always necessary to return the process to step S1.

Moreover, when there are automobiles other than automobile A, the order of priority may be determined according to a distance between automobile B and each of the other automobiles, and whether at least part of the second feature information of each of the other automobiles is identical to the first feature information may be determined in turn according to the determined order of priority.

Next, control unit 130 makes an inquiry to automobile A via communication unit 160 about whether pulling is possible (S5). Upon receiving the inquiry about whether pulling is possible, automobile A outputs the inquiry to display input device 11. Here, because the person in automobile A accepts the inquiry about whether pulling is possible via display input device 11, automobile A transmits the acceptance for the inquiry about whether pulling is possible to automobile B.

Next, control unit 130 of automobile B determines whether the acceptance for the inquiry about whether pulling is possible from automobile A has been received (S6). When automobile B has received the acceptance for the inquiry about whether pulling is possible from automobile A (YES in S6), control unit 130 causes communication between automobile A and automobile B to be established (S7). Automobile A that is one of one or more automobiles A becomes selected automobile 20a that is selected. As a result, automobile A and selected automobile 20a share, for example, travel path information about a path on which automobile A travels.

On the other hand, when automobile B has not received the acceptance for the inquiry about whether pulling is possible from automobile A (NO in S6), control unit 130 returns the process to step 51. As with the above case, in this case, when there are automobiles other than automobile A, the process may return to step S2 to determine whether at least part of the second feature information of each of the other automobiles is identical to the first feature information.

Next, control unit 130 switches from the manual mode in which the user drives automobile B to the automatic mode in which the automated driving is performed so that the movement of automobile B is linked to the movement of selected automobile 20a (S8). In other words, control unit 130 transmits an automatic mode switch command to the integration unit included in automobile B. The integration unit switches from the manual mode to the automatic mode to set automobile B to automatic control.

Next, when the movement of automobile B is linked to the movement of selected automobile 20a, control unit 130 transmits completion information indicating the completion of the linking to server 50 via communication unit 160, server 50 managing automobile B and selected automobile 20a (S9). In this way, automobile B is pulled by selected automobile 20a to the destination of the user in a manner that automobile B tracks selected automobile 20a. After that, this process returns to the start.

It should be noted that the present embodiment is not limited to the case of the same destination. When automobile B wants to go to city X, a destination thereof, and automobile A in surroundings of automobile B is traveling to city Y, a destination thereof on the way to city X, automobile B may make an inquiry to automobile A about whether pulling to city Y is possible. In this case, control unit 130 may determine that at least part of the second feature information is identical to the first feature information. In this way, automobile B may go through the relay point on the way to city X. After that, automobile B may look for another automobile traveling to city X.

### Advantageous effects

Next, the following describes advantageous effects produced by moving body assistance device 100, moving body assistance system 1, and the moving body assistance method according to the present embodiment.

As described above, moving body assistance device 100 according to the present embodiment is installed in automobile 10 and assists movement of automobile 10 by communicating with one or more automobiles 20 traveling in the surroundings of automobile 10. Moreover, moving body assistance device 100 includes: obtainment unit 120 that obtains identification information for identifying one or more automobiles 20 or at least one person in one or more automobiles 20, by receiving an optical signal transmitted by one or more automobiles 20; communication unit 160 that receives feature information from server 50 disposed outside of automobile 10 and one or more automobiles 20, the feature information corresponding to the identification information and indicating a feature about at least one or more automobiles 20 or the at least one person in one or more automobiles 20; and control unit 130 that determines whether a predetermined condition is satisfied according to the feature information, selects, as selected automobile 20a, one of one or more automobiles 20 according to a determination result, and causes communication unit 160 to establish communication with selected moving body 20a.

With this configuration, obtainment unit 120 obtains the second feature information for identifying each of one or more automobiles 20, or each of the at least one person in automobile 20, by receiving an optical signal transmitted by automobile 20. Control unit 130 determines whether the predetermined condition is satisfied according to the feature information. Accordingly, control unit 130 selects, as selected automobile 20a, one of one or more automobiles 20 according to the determination result. Control unit 130 causes communication unit 160 to establish the communication between automobile 10 and selected automobile 20a.

As a result, moving body assistance device 100 can extract a desired automobile from automobiles.

Moreover, moving body assistance system 1 according to the present embodiment includes automobile 10 including moving body assistance device 100, and one or more automobiles 20 including moving body assistance device 100.

Moreover, the moving body assistance method according to the present embodiment is a moving body assistance method for assisting movement of automobile 10 by communicating with one or more automobiles 20 traveling in surroundings of automobile 10. The moving body assistance method includes: obtaining identification information for identifying one or more automobiles 20 or at least one person in one or more automobiles 20, by receiving an optical signal transmitted by one or more automobiles 20; receiving, from server 50, feature information corresponding to the identification information and indicating a feature about one or more automobiles 20 or the at least one person in one or more automobiles 20; and determining whether a predetermined condition is satisfied according to the feature information, selecting, as selected automobile 20a, one of one or more automobiles 20 according to a determination result, and establishing communication with selected automobile 20a.

The system and method produce the same advantageous effects as above.

Moreover, moving body assistance device 100 according to the present embodiment further includes memory unit 140 that stores first feature information indicating a feature about a user in automobile 10. The feature information indicating the feature about the at least one person in one or more automobiles is second feature information. Control unit 130 determines whether the predetermined condition is satisfied by determining whether at least part of the second feature information obtained from server 50 is identical to the first feature information stored in memory unit 140.

With this configuration, controller 130 determines whether the predetermined condition is satisfied by determining whether the at least part of the second feature information obtained from server 50 is identical to the first feature information stored in memory unit 140. For this reason, it is possible to provide the user with the second feature information the at least part of which is identification to the condition of the user.

Moreover, in moving body assistance device 100 according to the present embodiment, control unit 130 causes communication unit 160 to establish communication between selected automobile 20a and automobile 10 when the at least part of the second feature information obtained is determined to be identical to the first feature information stored in memory unit 140. Further, control unit 130 switches from a manual mode in which the user drives automobile 10 to an automatic mode in which automated driving is performed so that movement of automobile 10 is linked to movement of selected automobile 20a. Subsequently, automobile 10 moves to a predetermined destination by automated driving.

With this configuration, when control unit 130 determines that at least part of the second feature information is identical to the first feature information, control unit 130 causes communication unit 160 to establish the communication between selected automobile 20a and automobile 10. Control unit 130 switches from the manual mode in which the user drives automobile 10 to the automatic mode in which automated driving is performed so that the movement of automobile 10 is linked to the movement of selected automobile 20a. In this way, automobile 10 is pulled by selected automobile 20a in a manner that automobile 10 tracks selected automobile 20a. In consequence, since automobile 10 is less likely to get away from selected automobile 20a, it is possible to maintain the reliability of the communication between automobile 10 and selected automobile 20a.

Moreover, in moving body assistance device 100 according to the present embodiment, automobile 10 moves by automated driving when movement of automobile 10 is linked with selected automobile 20a. Control unit 130 further makes an inquiry to selected automobile 20a via communication unit 160 about whether the linking of the movement of automobile 10 is possible, when the at least part of the second feature information obtained is determined to be identical to the first feature information stored in memory unit 140. In addition, control unit 130 causes communication unit 160 to establish the communication between selected automobile 20a and automobile 10 when an acceptance for the inquiry about whether the linking of the movement of automobile 10 is possible is obtained from selected automobile 20a.

With this configuration, when control unit 130 determines that the at least part of the second feature information is identical to the first feature information, control unit 130 makes the inquiry to selected automobile 20a about whether the linking of the movement of automobile 10 is possible. Control unit 130 causes communication unit 160 to establish the communication between selected automobile 20a and automobile 10 when the acceptance for the inquiry about whether the linking of the movement of automobile 10 is possible is obtained from selected automobile 20a. For this reason, it is possible to avoid a situation such as pulling some automobile before the person in automobile 20 notices. Consequently, any other automobile including moving body assistance device 100 improves safety.

Moreover, in moving body assistance device 100 according to the present embodiment, after the linking is started, control unit 130 transmits to server 50 completion information indicating completion of the linking.

With this configuration, because server 50 obtains the completion information from automobile 10, server can manage selected automobile 20a and automobile 10. Accordingly, any automobile including moving body assistance device 100 improves safety.

In particular, by server 50 receiving the completion information from automobile 10, for example, it is possible to levy a charge incurred for pulling.

Moreover, in moving body assistance device 100 according to the present embodiment, the second feature information includes information indicating a destination of one or more automobiles 20, and information indicating a charge incurred from when the linking is started to when the linking is ended. Control unit 130 outputs the second feature information for display.

With this configuration, by browsing the information indicating the destination of one or more automobiles 20 and the information indicating the charge incurred for pulling that are included in the second feature information, the user can select any of one or more automobiles 20 according to the user's needs.

Moreover, moving body assistance device 100 according to the present embodiment further includes display input device 11 that receives the first feature information including the predetermined destination, and displays the second feature information.

Moreover, in moving body assistance device 100 according to the present embodiment, the first feature information includes at least one of a destination of the user in automobile 10 and identification information for identifying automobile 10.

### Embodiment 2

The following describes moving body assistance device 100, moving body assistance system 1, and a moving body assistance method according to the present embodiment.

[Configuration]

The present embodiment differs from Embodiment 1 in that history information is outputted for display to a user of automobile 10. The configurations of moving body assistance device 100, moving body assistance system 1, and the moving body assistance method are the same as Embodiment 1, unless otherwise stated. Identical components are assigned the same reference signs, and overlapping detailed description thereof is omitted.

Control unit 130 obtains, from a selected moving body via communication unit 160, history information about history of the selected moving body, and outputs the history information for display. When at least part of second feature information is identical to first feature information, control unit 130 transmits identification information about automobile 20 to server 50 again. Server 50 searches for history information of automobile 20 corresponding to the identification information, and control unit 130 receives from server 50 the searched history information of automobile 20. Control unit 130 outputs the second feature information and the history information to display input device 11.

History information includes, for example, evaluations of a person in automobile 20 for pulling made by other people, word of mouth about the person, and history of past traveling by automobile 20. The history of past traveling may be obtained using, for example, a GPS (global positioning system).

[Operation]

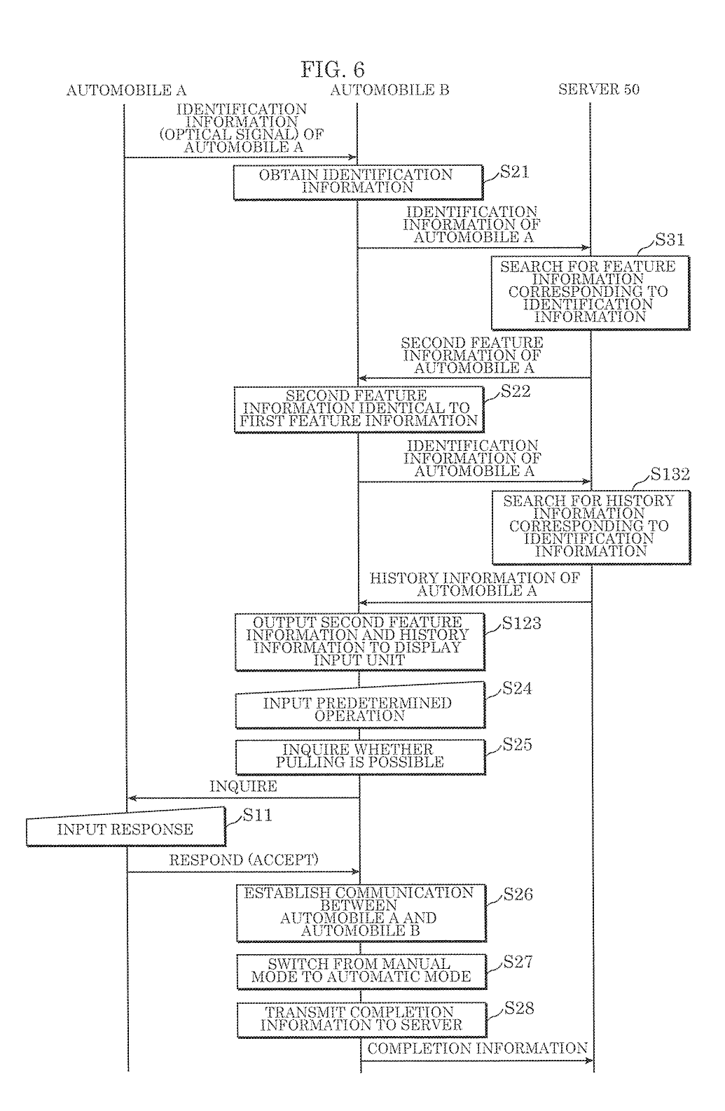

Next, the following describes the operation of moving body assistance device 100, moving body assistance system 1, and the moving body assistant method with reference to FIG. 6.

FIG. 6 is a sequence diagram illustrating the operation of moving body assistance system 1 according to Embodiment 2. In what follows, description of steps in FIG. 6 that are the same as those in FIG. 4 of Embodiment 1 is omitted.

As shown in FIG. 6, first, control unit 130 of automobile B obtains, via obtainment unit 120, an optical signal outputted by automobile A (51). Automobile B transmits to server 50 identification information about automobile A indicated by the optical signal.

Next, server 50 receives the identification information about automobile A from automobile B, and searches for feature information corresponding to the identification information. Since the feature information about automobile A is second feature information, server 50 transmits the second feature information to automobile B (S31).

Next, control unit 130 receives a condition corresponding to the second feature information about automobile A from server 50 via communication unit 160. Control unit 130 determines whether a predetermined condition is satisfied. Specifically, control unit 130 determines whether at least part of the second feature information is identical to first feature information stored in memory unit 140 (S22). Because the at least part of the second feature information is identical to the first feature information, control unit 130 transmits the identification information about automobile A to server 50 again.

It should be noted that although control unit 130 transmits the identification information about automobile 20 to server 50 again, control unit 130 may further receive history information from server 50 in step S31 before determining whether the at least part of the second feature information is identical to the first feature information.

Next, server 50 receives the identification information about automobile A from automobile B, and searches for history information corresponding to the identification information about automobile A (S132). Server 50 transmits the history information of automobile A to automobile B.

Next, control unit 130 outputs the second feature information and the history information to display input device 11 (S123). With this, the user browses the second feature information indicating the destination of automobile A, a charge, etc., and the history information displayed by display input device 11. The user checks the second feature information displayed by display input device 11, and inputs a predetermined operation (S24).

Next, control unit 130 makes an inquiry to automobile A via communication unit 160 about whether pulling is possible (S25).

Next, the person in automobile A inputs a response to the inquiry about whether pulling is possible from automobile B (S11).

Next, upon receiving the acceptance for the inquiry about whether pulling is possible from automobile A, control unit 130 of automobile B causes communication between another automobile A and automobile B to be established (S26).

Next, control unit 130 switches from the manual mode in which the user drives automobile B to the automatic mode in which the automated driving is performed so that movement of automobile B is linked to movement of selected automobile 20a (S27).

Next, when the movement of automobile B is linked to the movement of selected automobile 20a, control unit 130 transmits completion information indicating the completion of the linking to server 50 via communication unit 160, server 50 managing automobile B and selected automobile 20a (S28). In this way, automobile B is pulled by selected automobile 20a to the destination of the user in a manner that automobile B tracks selected automobile 20a. After that, this process returns to the start.

### Advantageous Effects

Next, the following describes advantageous effects produced by moving body assistance device 100, moving body assistance system 1, and the moving body assistance method according to the present embodiment.

As described above, in moving body assistance device 100 according to the present embodiment, control unit 130 obtains, from selected automobile 20a via communication unit 160, history information about history of the at least one person in selected automobile 20a, and outputs the history information for display.

With this configuration, the user can evaluate the at least one person in selected automobile 20a by browsing the history information about the at least one person in selected automobile 20a. For this reason, the user can select selected automobile 20a of the person having high reliability.

Moreover, in moving body assistance device 100 according to the present embodiment, the history information includes at least one of an evaluation of the at least one person in selected automobile 20a made by another person after the linking is completed, and history of past traveling by selected automobile 20a.

The present embodiment produces other advantageous effects that are the same as those produced by Embodiment 1.

### Other Variations etc.

Although the present disclosure has been described in accordance with the embodiments, the present disclosure is not limited to the aforementioned embodiments.

For example, in the moving body assistance device and the moving body assistance system according to each of the aforementioned embodiments, the moving body assistance device may include the integration unit, the accelerator actuator, the brake actuator, the steering actuator, etc. In addition, the control unit may include the integration unit.

Moreover, in the moving body assistance device and the moving body assistance system according to each of the aforementioned embodiments, the moving body assistance device may cause another automobile to send an optical signal indicating identification information by causing the light-emitting unit of the other automobile to emit light by detecting an optical signal sent by an automobile with an optical sensor.

Moreover, in the moving body assistance device and the moving body assistance system according to each of the aforementioned embodiments, the other automobile need not include the moving body assistance device. In other words, the other automobile may only include the light-emitting unit that outputs an identification signal, and the display input device.

Moreover, in the moving body assistance device and the moving body assistance system according to each of the aforementioned embodiments, although the number of automobiles that can be linked to the other automobile may be any number of automobiles, it is desirable that the number of automobiles be approximately two or three.

Moreover, in the moving body assistance device and the moving body assistance system according to each of the aforementioned embodiments, it is supposed that when the automobile that is pulled wants to stop on the way somewhere, the automobile sends a request for stopping on the way somewhere etc. to the other automobile. In this case also, because communication has been established between the other automobile and the automobile, it is possible to flexibly respond to stopping on the way somewhere and a request for stopping on the way somewhere.

Moreover, in the moving body assistance device and the moving body assistance system according to each of the aforementioned embodiments, although the other automobile is identified by the obtainment unit receiving the optical signal, the other automobile may be identified by, for example, capturing an image of a license plate.

Moreover, each of processing units included in the moving body assistance device, the moving body assistance system, and the moving body assistance method according to each of the aforementioned embodiments is typically implemented as LSI (large scale integration) that is an integrated circuit. These may be implemented in a single chip individually, or in a single chip that includes some or all of them.

Moreover, the method of circuit integration is not limited to LSI. Integration may be implemented with a dedicated circuit or a general-purpose processor. A field programmable gate array (FPGA) that can be programmed after manufacturing LSI or a reconfigurable processor that allows reconfiguration of the connections and settings of circuit cells inside the LSI may be used.

It should be noted that in each of the aforementioned embodiments, the structural components may be each configured using dedicated hardware or may be each realized by executing a software program suitable for the structural component. Each of the structural components may be implemented by a program executing unit, such as a CPU or a processor, reading and executing a software program recorded on a recording medium, such as a hard disk or a semiconductor memory.

Moreover, the numerals used above are all examples for specifically describing the present disclosure, and thus the embodiments of the present disclosure are not limited to the illustrated numerals.

Moreover, the division of the functional blocks in the block diagram is one example, and functional blocks may be achieved as one functional block, one functional block may be divided into blocks, or some of functions may be transferred to other functional blocks. Further, single hardware or software may process similar functions of functional blocks, in parallel or by time division.

Moreover, the order in which the steps are performed in the flow chart is one example for specifically describing the present disclosure, and order other than the above order may be used. Further, some of the steps may be performed simultaneously (in parallel) with other steps.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A moving body assistance device that is installed in a first moving body and assists movement of the first moving body by communicating with at least one second moving body traveling in surroundings of the first moving body, the moving body assistance device comprising:
an obtainment unit that obtains identification information for identifying the at least one second moving body or at least one person in the at least one second moving body, by receiving an optical signal transmitted by the at least one second moving body;
a communication unit that receives feature information from a server disposed outside of the first moving body and the at least one second moving body, the feature information corresponding to the identification information and indicating a feature about the at least one second moving body or the at least one person in the at least one second moving body; and
a control unit that determines whether a predetermined condition is satisfied according to the feature information, selects, as a selected moving body, one of the at least one second moving body according to a determination result, and causes the communication unit to establish communication with the selected moving body.

2. The moving body assistance device according to claim 1, further comprising:
a memory unit that stores first feature information indicating a feature about a user in the first moving body,
wherein, when the feature information indicating the feature about the at least one person in the at least one second moving body is second feature information, the control unit determines whether the predetermined condition is satisfied by determining whether at least part of the second feature information obtained from the server is identical to the first feature information stored in the memory unit.

3. The moving body assistance device according to claim 2,
wherein the control unit:
causes the communication unit to establish communication between the selected moving body and the first moving body when the at least part of the second feature information obtained is determined to be identical to the first feature information stored in the memory unit; and
switches from a manual mode in which the user drives the first moving body to an automatic mode in which automated driving is performed so that movement of the first moving body is linked to movement of the selected moving body.

4. The moving body assistance device according to claim 3,
wherein the first moving body moves by automated driving when movement of the first moving body is linked with the at least one second moving body, and
the control unit further:
makes an inquiry to the selected moving body via the communication unit about whether the linking of the movement of the first moving body is possible, when the at least part of the second feature information obtained is determined to be identical to the first feature information stored in the memory unit; and
causes the communication unit to establish the communication between the selected moving body and the first moving body when an acceptance for the inquiry about whether the linking of the movement of the first moving body is possible is obtained from the selected moving body.

5. The moving body assistance device according to claim 3,
wherein after the linking is started, the control unit transmits to the server completion information indicating completion of the linking.

6. The moving body assistance device according to claim 3,
wherein the second feature information includes information indicating a destination of the at least one second moving body, and information indicating a charge incurred from when the linking is started to when the linking is ended, and
the control unit outputs the second feature information for display.

7. The moving body assistance device according to claim 3,
wherein the control unit obtains, from the selected moving body via the communication unit, history information about history of the at least one person in the selected moving body, and outputs the history information for display.

8. The moving body assistance device according to claim 7,
wherein the history information includes at least one of an evaluation of the at least one person in the selected moving body made by another person after the linking is completed, and history of past traveling by the selected moving body.

9. The moving body assistance device according to claim 3, further comprising:
a display input unit that receives the first feature information including a predetermined destination, and displays the second feature information.

10. The moving body assistance device according to claim 2,
wherein the first feature information includes at least one of a destination of the user in the first moving body and identification information for identifying the first moving body.

11. A moving body assistance system, comprising:
a first moving body and at least one second moving body each having installed therein a corresponding moving body assistance device according to claim 1.

12. A moving body assistance method for assisting movement of a first moving body by communicating with at least one second moving body traveling in surroundings of the first moving body, the moving body assistance method comprising:
obtaining identification information for identifying the at least one second moving body or at least one person in the at least one second moving body, by receiving an optical signal transmitted by the at least one second moving body;
receiving, from a server, feature information corresponding to the identification information and indicating a feature about the at least one second moving body; and
determining whether a predetermined condition is satisfied according to the feature information, selecting, as a selected moving body, one of the at least one second moving body according to a determination result, and establishing communication with the selected moving body.
